(19) United States
(12) Patent Application Publication
(10) Pub. No.: US 2008/0008241 A1
(43) Pub. Date: Jan. 10, 2008

(54) Method and apparatus for encoding/decoding a first frame sequence layer based on a second frame sequence layer

(76) Inventors: Seung Wook Park, Seoul (KR); Ji Ho Park, Gangnam-gu (KR); Byeong Moon Jeon, Seoul (KR); Doe Hyun Yoon, Seoul (KR)

Correspondence Address: HARNESS, DICKEY & PIERCE, P.L.C., P.O. BOX 8910, RESTON, VA, 20195, US

(21) Appl. No.: 11/288,440

(22) Filed: Nov. 29, 2005

Related U.S. Application Data
(60) Provisional application No. 60/631,177, filed on Nov. 29, 2004.
(60) Provisional application No. 60/648,422, filed on Feb. 1, 2005.
(60) Provisional application No. 60/643,162, filed on Jan. 13, 2005.

(51) Int. Cl. H04N 7/12

(52) U.S. Cl. 375/240.16; 375/E07.105

(57) ABSTRACT

In one embodiment of a method of decoding a first frame sequence layer, at least one motion vector of an image block in a frame of the first frame sequence layer is determined based on a motion vector for an image block in a frame of a second frame sequence layer. Here, the frame of the second frame sequence layer is temporally separated from the frame of the first frame sequence layer. The image block in the frame of the first frame sequence layer is decoded based on the determined motion vector.

### DOMESTIC PRIORITY INFORMATION

This application claims priority under 35 U.S.C. §119 on U.S. Provisional Application Nos. 60/631,177 filed Nov. 29, 2004, 60/648,422 filed Feb. 1, 2005, and 60/643,162 filed Jan. 13, 2005; the entire contents of each of which are hereby incorporated by reference.

### BACKGROUND OF THE INVENTION

1. Field of the Invention

The present invention relates to scalable encoding and decoding of video signals, and more particularly to a method and apparatus for encoding a video signal in a scalable Motion Compensated Temporal Filtering (MCTF) scheme and a method and apparatus for decoding such encoded video data.

2. Description of the Related Art

It is difficult to allocate the large bandwidth required for TV signals to digital video signals wirelessly transmitted and received by mobile phones, notebook computers, mobile TVs, handheld PCs, etc. Thus, video compression standards for use with such devices strive for high video signal compression efficiencies.

Such devices have a variety of processing and presentation capabilities so that a variety of compressed video data forms may be prepared. Accordingly, the same video source desirable should be provided in a variety of forms corresponding to the numerous variations and combinations thereof such as the number of frames transmitted per second, resolution, the number of bits per pixel, etc. This, however, imposes a great burden on content providers.

In view of the above, content providers prepare high-bitrate compressed video data and perform, upon receiving a request from a device, a process of decoding compressed video and encoding the video back into video data suited to the video processing capabilities of the device. The re-embedded video data is then supplied to the mobile device. This method entails a transcoding procedure including decoding and encoding processes, that causes some time delay in providing the requested data to the device. The transcoding procedure also requires complex hardware and algorithms to cope with the wide variety of target encoding formats.

A Scalable Video Codec (SVC) has been proposed in an attempt to overcome these problems. This scheme encodes video into a sequence of pictures with the highest image quality while ensuring that part of the encoded picture sequence (specifically, a partial sequence of frames intermittently selected from the total sequence of frames) can be decoded and used to represent the video with a low image quality. Motion Compensated Temporal Filtering (MCTF) is an encoding scheme that has been suggested for use in the scalable video codec.

Although it is possible to represent low image-quality video by receiving and processing part of the sequence of pictures encoded in the scalable MCTF coding scheme as described above, there is still a problem in that the image quality is significantly reduced if the bitrate is lowered. One solution to this problem is to provide an auxiliary picture sequence for low bitrates, for example, a sequence of pictures that have a small screen size and/or a low frame rate.

The auxiliary picture sequence is referred to as a base layer, and the one or more higher quality sequences are referred to as enhanced or enhancement layers. Video signals of the base and enhanced layers have redundancy since the same video signal source is encoded into the two or more layers. To increase the coding efficiency of the enhanced layer according to the MCTF scheme, one method converts each video frame of an enhanced layer into a predictive image based on a video frame of the base layer temporally coincident with the enhanced layer video frame. Another method codes motion vectors of a picture in the enhanced layer using motion vectors of a picture in the base layer temporally coincident with the enhanced layer picture. FIG. 1 illustrates how a picture in the enhanced layer is coded using motion vectors of a temporally coincident picture in the base layer.

The motion vector coding method illustrated in FIG. 1 is performed in the following manner. If the screen size of frames in the base layer is less than the screen size of frames in the enhanced layer, a base layer frame F1 temporally coincident with a current enhanced layer frame F10, which is to be converted into a predictive image, is enlarged to the same size as the enhanced layer frame. Here, motion vectors of macroblocks in the base layer frame are also scaled up by the same ratio as the enlargement ratio of the base layer frame.

A motion vector mv1 of each macroblock MB10 in the enhanced layer frame F10 is determined through motion estimation. The motion vector mv1 is compared with a motion vector mvScaledBL1 obtained by scaling up a motion vector mvBL1 of a macroblock MB1 in the base layer frame F1, which covers an area in the base layer frame F1 corresponding to the macroblock MB10. If both the enhanced and base layers use macroblocks of the same size (for example, 16×16 macroblocks), a macroblock in the base layer covers a larger area in a frame than a macroblock in the enhanced layer. The motion vector mvBL1 of the macroblock MB1 in the base layer frame F1 is determined by a base layer encoder before the enhanced layer is encoded.

If the two motion vectors mv1 and mvScaledBL1 are identical, a value indicating that the motion vector mv1 of the macroblock MB10 is identical to the scaled motion vector mvScaledBL1 of the corresponding block MB1 in the base layer is recorded in a block mode of the macroblock MB10. If the two motion vectors mv1 and mvScaledBL1 are different, the difference between the two motion vectors mv1 and mvScaledBL1 is coded and added to the encoded video signal in association with the macroblock MB10, provided that coding of the vector difference (i.e., mv1−mvScaledBL1) is advantageous over coding of the motion vector mv1. This reduces the amount of vector data to be coded in the enhanced layer coding procedure.

However, since the base and enhanced layers are encoded at different frame rates, many frames in the enhanced layer have no temporally coincident frames in the base layer. For example, an enhanced layer frame (Frame B) shown in FIG. 1 has no temporally coincident frame in the base layer. The above methods for increasing the coding efficiency of the enhanced layer cannot be applied to certain frames (e.g., Frame B) because these frames have no temporally coincident frame in the base layer.

### SUMMARY OF THE INVENTION

The present invention relates to encoding and decoding methods and apparatuses.

In one embodiment of a method of decoding a first frame sequence layer, at least one motion vector of an image block in a frame of the first frame sequence layer is determined based on a motion vector for an image block in a frame of a second frame sequence layer. Here, the frame of the second frame sequence layer is temporally separated from the frame of the first frame sequence layer. The image block in the frame of the first frame sequence layer is decoded based on the determined motion vector.

In one embodiment, for example, the display size of frames in the second frame sequence layer is less than a display size of frames in the first frame sequence layer.

In one embodiment, a scaled motion vector of the image block in the frame of the second frame sequence layer is determined, and then at least one motion vector of the image block in the frame of the first frame sequence layer is determined based on the determined scaled motion vector and a temporal difference between the frame of the first frame sequence layer and the frame of the second frame sequence layer.

In another embodiment, a derivative motion vector is obtained by altering the motion vector of the image block in the frame of the second frame sequence layer based on a temporal difference between the frame of the first frame sequence layer and the frame of the second frame sequence layer and then scaling the altered motion vector. Then, at least one motion vector of the image block in the frame of the first frame sequence layer is determined based on the derivative motion vector.

In yet another embodiment, motion vector information is obtained from the first frame sequence layer, and at least one motion vector of the image block in the frame of the first frame sequence layer is determined based on the motion vector for the image block in the frame of the second frame sequence layer and the obtained motion vector information.

In a still further embodiment of a method of decoding a first frame sequence layer, the first frame sequence layer and a second frame sequence layer are received. Here, a display size of frames in the second frame sequence layer is less than a display size of frames in the first frame sequence layer. At least one motion vector of an image block in a frame of the first frame sequence layer is determined based on a motion vector for an image block in a frame of a second frame sequence layer, a display size difference between frames in the first frame sequence layer and frames in the second frame sequence layer, and a time difference between the frame of the first frame sequence layer and the frame of the second frame sequence layer. The frame of the second frame sequence layer is temporally separated from the frame of the first frame sequence layer. The image block in the frame of the first frame sequence layer is decoded based on the determined motion vector.

In an embodiment of a method of encoding a video signal, the video signal is encoded to produce a first frame sequence layer and a second frame sequence layer. At least one frame in the first frame sequence layer includes an image block having motion vector information derived based on a motion vector for an image block in a frame of the second frame sequence layer. Here, the frame of the second frame sequence layer is temporally separated from the frame in the first frame sequence layer.

In an embodiment of an apparatus for decoding a first frame sequence layer, a first frame sequence layer decoder is configured to determine at least one motion vector of an image block in a frame of the first frame sequence layer based on a motion vector for an image block in a frame of a second frame sequence layer. Here, the frame of the second frame sequence layer is temporally separated from the frame of the first frame sequence layer. The first frame sequence layer is further configured to decode the image block in the frame of the first frame sequence layer based on the determined motion vector. A second frame sequence layer decoder is configured to receive the second frame sequence layer and output the motion vector of the image block in the frame of the second frame sequence layer.

In an embodiment of an apparatus for encoding a video signal, a first encoder is configured to encode the video signal to produce a first frame sequence layer, and a second encoder is configured to encode the video signal to produce a second frame sequence layer. The first encoder is configured to produce at least one frame in the first frame sequence layer including an image block having motion vector information derived based on a motion vector for an image block in a frame of the second frame sequence layer. Here, the frame of the second frame sequence layer is temporally separated from the frame in the first frame sequence layer.

### BRIEF DESCRIPTION OF THE DRAWINGS

The present invention will become more fully understood from the detailed description given herein below and the accompanying drawings, wherein like elements are represented by like reference numerals, which are given by way of illustration only and thus are not limiting of the present invention and wherein:

FIG. 1 illustrates how a picture in the enhanced layer is coded using motion vectors of a temporally coincident picture in the base layer;

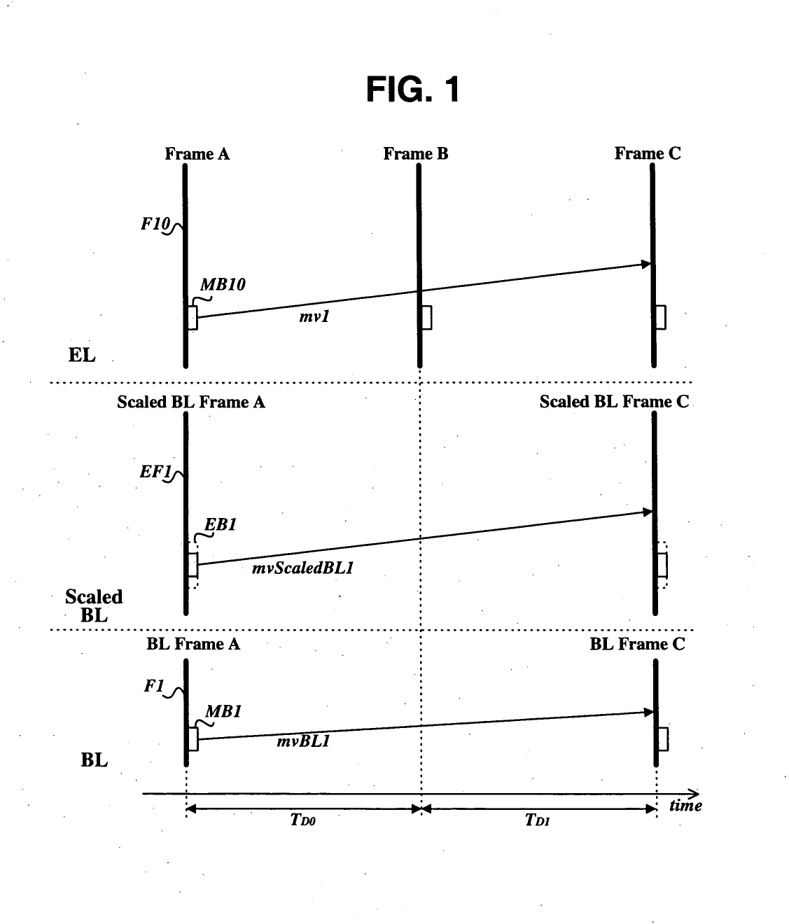

FIG. 2 is a block diagram of a video signal encoding apparatus to which a video signal coding method according to an embodiment of the present invention is applied;

FIG. 3 is a block diagram showing part of a filter responsible for performing image estimation/prediction and update operations in the encoder of FIG. 2;

FIGS. 4a and 4b illustrate how a motion vector of a target macroblock in an enhanced layer frame, to be coded into a predictive image, is determined using a motion vector of a base layer frame temporally separated from the enhanced layer frame according to an embodiment of the present invention;

FIG. 5 is a block diagram of an apparatus for decoding a data stream encoded by the apparatus of FIG. 2; and

FIG. 6 is a block diagram showing part of an inverse filter responsible for performing inverse prediction and update operations in the decoder of FIG. 5.

### DETAILED DESCRIPTION OF EXAMPLE EMBODIMENTS

Example embodiments of the present invention will now be described in detail with reference to the accompanying drawings.

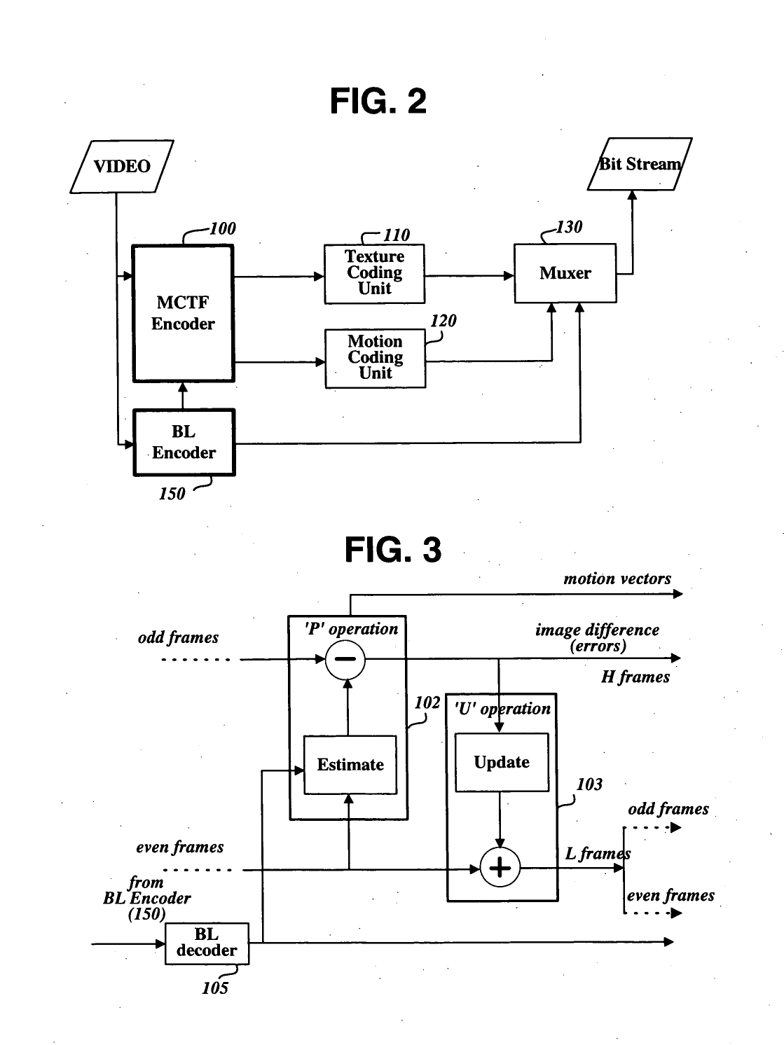

FIG. 2 is a block diagram of a video signal encoding apparatus to which a scalable video signal coding method according to an embodiment of the present invention is applied.

The video signal encoding apparatus shown in FIG. 2 includes a motion compensated temporal filter (MCTF) encoder 100, a texture coding unit 110, a motion coding unit 120, a base layer encoder 150, and a muxer (or multiplexer) 130. The MCTF encoder 100 encodes an input video signal in units of macroblocks according to an MCTF scheme, and generates suitable management information. The texture coding unit 110 converts information of encoded macroblocks into a compressed bitstream. The motion coding unit 120 codes motion vectors of image blocks obtained by the MCTF encoder 100 into a compressed bitstream according to a specified scheme. The base layer encoder 150 encodes an input video signal according to a specified scheme, for example, according to the MPEG-1, 2 or 4 standard or the H.261, H.263 or H.264 standard, and produces a small-screen picture sequence (e.g., a sequence of pictures scaled down to 25% of their original size). The muxer 130 encapsulates the output data of the texture coding unit 110, the picture sequence output from the base layer encoder 150, and the output vector data of the motion coding unit 120 into a desired format. The muxer 130 then multiplexes and outputs the encapsulated data into a desired transmission format. The base layer encoder 150 may provide a low-bitrate data stream not only by encoding an input video signal into a sequence of pictures having a smaller screen size than pictures of the enhanced layer but also by encoding an input video signal into a sequence of pictures having the same screen size as pictures of the enhanced layer at a lower frame rate than the enhanced layer. For the purposes of example only, the embodiments of the present invention described below, the base layer is encoded into a small-screen picture sequence. Namely, a display size of pictures in the base layer is less than a display size of pictures in the enhanced layer.

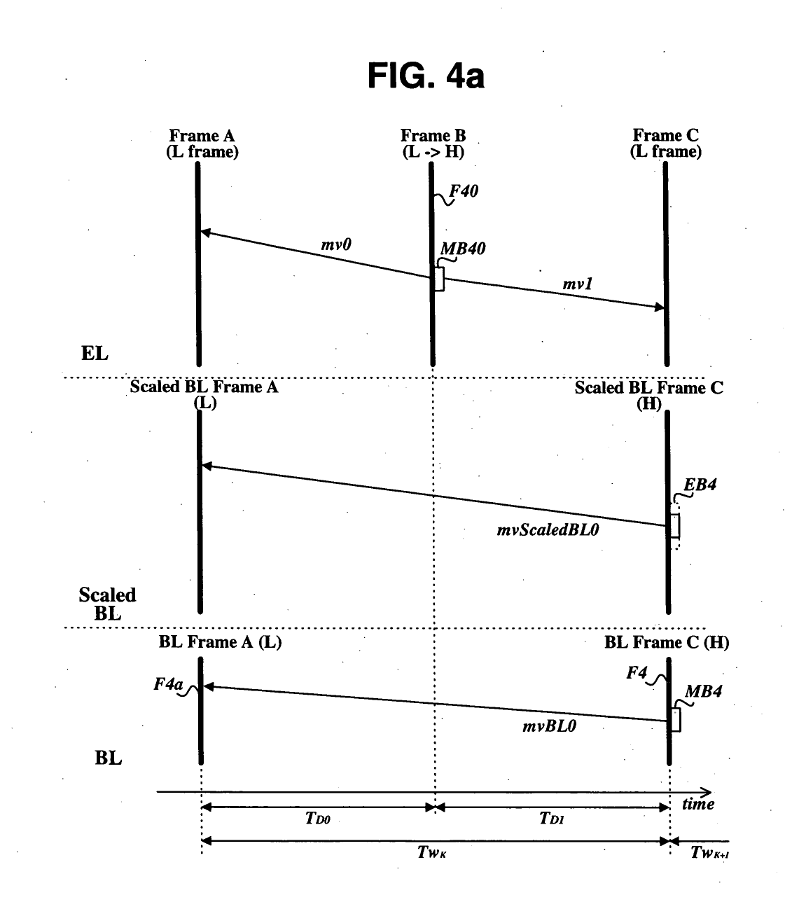

The MCTF encoder 100 performs motion estimation and prediction operations on each target macroblock in a video frame. The MCTF encoder 100 also performs an update operation on each target macroblock by adding an image difference of the target macroblock from a corresponding macroblock in a neighbor frame to the corresponding macroblock in the neighbor frame. FIG. 3 is a block diagram of part of a filter that performs these operations.

The MCTF encoder 100 separates an input video frame sequence into odd and even frames and then performs estimation/prediction and update operations on a certain-length sequence of pictures, for example, on a Group Of Pictures (GOP), a plurality of times until the number of L frames (discussed below), which are produced by the update operation, is reduced to, for example, one. FIG. 3 shows elements associated with estimation/prediction and update operations at one of a plurality of the MCTF levels.

The elements of FIG. 3 include an estimator/predictor 102, an updater 103, and a base layer (BL) decoder 105. The BL decoder 105 extracts a motion vector of each motion-estimated (inter-frame mode) macroblock from a stream encoded by the base layer encoder 150 and scales up the motion vector of each motion-estimated macroblock by an upsampling ratio that would restore the sequence of small-screen pictures to their original image size. Through motion estimation, the estimator/predictor 102 searches for a reference block of each target macroblock of a current frame, which is to be coded to residual data, in a neighbor frame prior to or subsequent to the current frame, and determines an image difference (i.e., a pixel-to-pixel difference) of the target macroblock from the reference block. A frame produced by the image difference blocks is referred to as a high or ‘H’ frames. The estimator/predictor 102 directly calculates a motion vector of the target macroblock with respect to the reference block or generates motion vector information that uses a motion vector of a corresponding block scaled by the BL decoder 105. The updater 103 performs an update operation by multiplying the image difference by an appropriate constant (for example, ½ or ¼) and adding the resulting value to the reference block. The operation carried out by the updater 103 is referred to as a ‘U’ operation, and a frame produced by the ‘U’ operation is referred to as a low or ‘L’ frame.

The estimator/predictor 102 and the updater 103 of FIG. 2 may perform their operations on a plurality of slices, which are produced by dividing a single frame, simultaneously and in parallel instead of performing their operations on the video frame. A frame (or slice) having an image difference (i.e., a predictive image), which is produced by the estimator/predictor 102, is referred to as an ‘H’ frame (or slice) since the difference value data in the ‘H’ frame (or slice) reflects high frequency components of the video signal. In the following description of the embodiments, the term ‘frame’ is used in a broad sense to include a ‘slice’, provided that replacement of the term ‘frame’ with the term ‘slice’ is technically permissible.

More specifically, the estimator/predictor 102 divides each of the input video frames (or each L frame obtained at the previous level) into macroblocks of a certain size. The estimator/predictor 102 codes each target macroblock of an input video frame through inter-frame motion estimation. The estimator/predictor 102 directly determines a motion vector of the target macroblock. Alternatively, if a temporally coincident frame is present in the enlarged base layer frames received from the BL decoder 105, the estimator/predictor 102 records, in an appropriate header area of the target image different difference macroblock, information which allows the motion vector of the target macroblock to be determined using a motion vector of a corresponding block in the temporally coincident base layer frame.

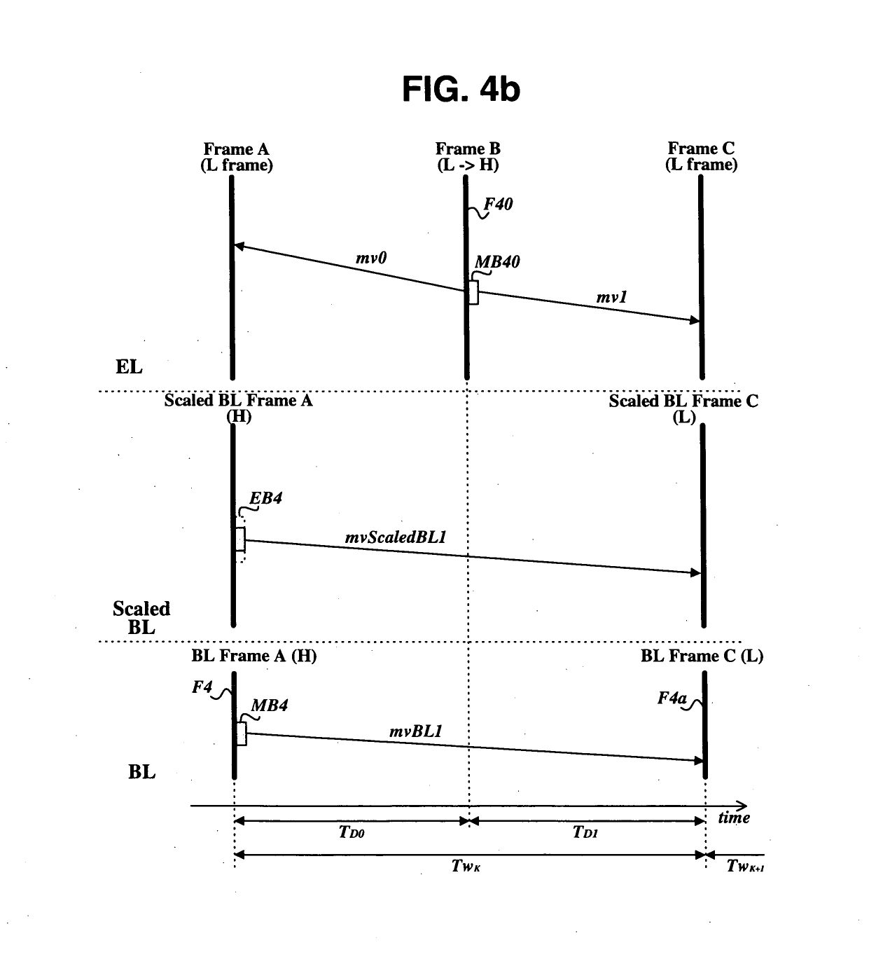

As will be appreciated, the above described processes and structure have not been described in great detail as they are known in the art and not necessarily directly related to the present invention. Instead, modifications according to embodiments of the present invention will be described in detail. For instance, example procedures for determining motion vectors of macroblocks in an enhanced layer frame using motion vectors of a base layer frame temporally separated from the enhanced layer frame according to embodiments of the present invention will now be described in detail with reference to FIGS. 4a and 4b.

In the example of FIG. 4a, a frame (Frame B) F40 is a current frame to be encoded into a predictive image frame (H frame), and a base layer frame (Frame C) is a coded predictive frame in a frame sequence of the base layer. If a frame temporally coincident with the current enhanced layer frame F40, which is to be converted into a predictive image, is not present in the frame sequence of the base layer, the estimator/predictor 102 searches for a predictive frame (e.g., Frame C) in the base layer, which is temporally closest to the current frame F40. Namely, the estimator/predictor 102 searches for information regarding the predictive frame (Frame C) in encoding information received from the BL decoder 105.

In addition, for a target macroblock MB40 in the current frame F40 which is to be converted into a predictive image, the estimator/predictor 102 searches for a macroblock most highly correlated with the target macroblock MB40 in adjacent frames prior to and/or subsequent to the current frame in the enhanced layer, and codes an image difference of the target macroblock MB40 from the found macroblock. Such an operation of the estimator/predictor 102 is referred to as a ‘P’ operation. The block most highly correlated with a target block is a block having the smallest image difference from the target block. The image difference of two image blocks is defined, for example, as the sum or average of pixel-to-pixel differences of the two image blocks. The block having the smallest image difference with the target block is referred to as a reference block. One reference block may be present in each of the reference frames and thus a plurality of reference blocks may be present for each target macroblock.

For example, if two reference blocks of the target macroblock MB40 are found in the prior and subsequent frames and the target macroblock MB40 is assigned a bidirectional (Bid) mode as shown in FIG. 4a, the estimator/predictor 102 derives two motion vectors mv0 and mv1 originating from the target macroblock MB40 extending to the two reference blocks using a motion vector mvBL0 of a corresponding block MB4 in a predictive frame F4 in the base layer, which is temporally closest to the current frame F40. The corresponding block MB4 is a block in the predictive frame F4 which would have an area EB4 covering a block having the same size as the target macroblock MB40 when the predictive frame F4 is enlarged to the same size of the enhanced layer frame. Motion vectors of the base layer are determined by the base layer encoder 150, and the motion vectors are carried in a header of each macroblock and a frame rate is carried in a GOP header. The BL decoder 105 extracts necessary encoding information, which includes a frame time, a frame size, and a block mode and motion vector of each macroblock, from the header, without decoding the encoded video data, and provides the extracted information to the estimator/predictor 102.

The estimator/predictor 102 receives the motion vector mvBL0 of the corresponding block MB4 from the BL decoder 105, and scales up the received motion vector mvBL0 by the ratio of the screen size of enhanced layer frames to the screen size of base layer frames. Then, the estimator/predictor 102 calculates derivative vectors mv0′ and mv1′ corresponding to motion vectors (for example, mv0 and mv1) determined for the target macroblock MB40 by Equations (1a) and (1b).
mv0′=mvScaledBL0×TDO/(TDO+TD1) (1a)
mv1′=−mvScaledBL0×TD1/(TDO+TD1) (1b)

Here, “TD1 ” and “TD0” denote time differences between the current frame F40 and two base layer frames (i.e., the predictive frame F4 temporally closest to the current frame F40 and a reference frame F4a of the predictive frame F4).

Equations (1a) and (1b) obtain two derivative motion vectors mv0′ and mv1′ of the scaled motion vector mvScaledBL0 that are respectively in proportion to the two time differences TD0 and TD1 of the current frame F40 with respect to the two base layer frames F4 and F4a, which is also the same proportion to the two reference frames (or reference blocks) in the enhanced layer. If a target vector to be derived (“mv1” in the example of FIG. 4a) and the scaled motion vector mvScaledBL0 of the corresponding block are in opposite directions, the estimator/predictor 102 obtains a derivative vector mv1′ by multiplying the product of the scaled motion vector mvScaledBL0 and the time difference ratio TD1/(TD0+TD1) by −1 as expressed in Equation (1b).

If the derivative vectors mv0′ and mv1′ obtained in this manner are identical to the actual motion vectors mv0 and mv1 which have been directly determined, the estimator/predictor 102 merely records or adds information indicating that the motion vectors of the target macroblock MB40 are identical to the derivative vectors, in the header of the target macroblock MB40, without transferring the actual motion vectors mv0 and mv1 to the motion coding unit 120. That is, the motion vectors of the target macroblock MB40 are not coded in this case.

If the derivative vectors mv0′ and mv1′ are different from the actual motion vectors mv0 and mv1 and if coding of difference vectors (e.g., mv0−mv0′ and mv1−mv1′—the difference between the actual motion vectors and the derivative motion vectors) is advantageous over coding of the actual vectors mv0 and mv1 in terms of, for example, the amount of data, the estimator/predictor 102 transfers the difference vectors to the motion coding unit 120 so that the difference vectors are coded by the motion coding unit 120. The motion coding unit 120 adds or records information, which indicates that the difference vectors have been coded into the encoded video signal, in the header of the target macroblock MB40. If coding of the difference vectors mv0−mv0′ and mv1−mv1′ is disadvantageous, the actual vectors mv0 and mv1, which have been previously obtained, are coded into the encoded video signal.

Only one of the two frames F4 and F4a in the base layer temporally closest to the current frame F40 is a predictive frame. Accordingly, there is no need to carry information indicating which one of the two neighbor frames in the base layer has the motion vectors used to encode motion vectors of the current frame F40 since a base layer decoder can specify the predictive frames in the base layer when performing decoding. Therefore, in this embodiment, the information indicating which base layer frame has been used is not recorded or added to the encoded video signal when the value indicating derivation from motion vectors in the base layer is recorded and carried in the header of a macroblock in an H frame.

In the example of FIG. 4b, a frame (Frame B) F40 is a current frame to be encoded into a predictive image, and a base layer frame (Frame A) is a coded predictive frame in a frame sequence of the base layer. In this example, the direction of a scaled motion vector mvScaledBL1 of a corresponding block MB4, which is to be used to derive motion vectors of a target macroblock MB40, is opposite to that of the example shown in FIG. 4a. Accordingly, Equations (1a) and (1b) used to derive the motion vectors in the example of FIG. 4a are replaced with Equations (2a) and (2b).
mv0′=−mvScaledBL1×TDO/(TDO+TD1) (2a)
mv1′=mvScaledBL1−TD1/(TDO+TD1) (2b)

Meanwhile, the corresponding block MB4 in the predictive frame F4 in the base layer, which is temporally closest to the current frame F40 to be coded into a predictive image, may have a unidirectional (Fwd or Bwd) mode rather than the bidirectional (Bid) mode. If the corresponding block MB4 has a unidirectional mode, the corresponding block MB4 may have a motion vector that spans a time interval other than the time interval TwK between adjacent frames (Frame A and Frame C) prior to and subsequent to the current frame F40. For example, if the corresponding block MB4 in the base layer has a backward (Bwd) mode in the example of FIG. 4a, the corresponding block MB4 may have a vector that spans the next time interval TwK+1. Also in this case, Equations (1a) and (1b) or Equations (2a) and (2b) may be used to derive motion vectors of the target macroblock MB40 in the current frame F40.

Specifically, when “mvBL0i” denotes a vector of the corresponding block MB4, which spans the next time interval TWK+1, and “mvScaledBL0i” denotes a scaled vector of the vector mvBL0i, “−mvScaledBL0i”, instead of “mvScaledBL”, is substituted into Equation (1a) in the example of FIG. 4a to obtain a target derivative vector mv0′ (i.e., mv0′=−mvScaledBL0i×TDO/(TDO+TD1)) since the target derivative vector mv0′ and the scaled vector mvScaledBL0i are in opposite directions. On the other hand, “−mvScaledBL0i” is multiplied by −1 in Equation (1b) to obtain the target derivative vector mv1′ (i.e., mv1′=−1×(−mvScaledBL0i)×TD1/(TDO+TD1)=mvScaledBL0i×TD1/(TDO+TD1)) since the target derivative vector mv1′ and the scaled vector mvScaledBL0i are in the same direction.

The two resulting equations are identical to Equations (2a) and (2b).

Similarly, if the corresponding block MB4 in the frame (Frame A) in the base layer has a forward (Fwd) mode rather than the bidirectional mode in the example of FIG. 4b, the target derivative vectors can be obtained by substituting a scaled vector of the motion vector of the corresponding block MB4 into Equations (1a) and (1b).

Thus, even if the corresponding block in the base layer has no motion vector in the same time interval as the time interval between the adjacent frames prior to and subsequent to the current frame in the enhanced layer, motion vectors of the target macroblock in the current frame may be derived using the motion vector of the corresponding block if Equations (1a) and (1b) or Equations (2a) and (2b) are appropriately selected and used taking into account the direction of the motion vector of the corresponding block in the base layer.

Instead of scaling up the motion vector in the base layer and multiplying the scaled motion vector by the time difference ratio TD0/(TD0+TD1) or TD1/(TD0+TD1) as in Equations (1a) and (1b) or Equations (2a) and (2b), it is also possible to first multiply the motion vector in the base layer by the time difference ratio TD0/(TD0+TD1) or TD1/(TD0+TD1) and then scale up the multiplied motion vector to obtain a derivative vector of the target macroblock in the enhanced layer.

The method, in which the motion vector of the base layer is scaled up and then multiplied by the time difference ratio, may be advantageous in terms of the resolution of the derivative vectors. For example, if the size of a base layer picture is 25% that of an enhanced layer picture and each of the enhanced and base layer frames has the same time difference from its two adjacent frames, scaling of the motion vector of the base layer is multiplication of each component of the motion vector by 2, and multiplication by the time difference ratio is division (e.g., by 2). Accordingly, the method, in which the motion vector of the base layer is scaled up and then multiplied by the time difference ratio, may obtain derivative vectors whose components are odd numbers. By contrast, the method, in which the motion vector of the base layer is scaled up (for example, multiplied by 2) after being multiplied by the time difference ratio (for example, divided by 2), cannot obtain derivative vectors whose components are odd numbers due to truncation in the division. Thus, it may be more beneficial in certain applications to use the method in which the motion vector of the base layer is scaled up and then multiplied by the time difference ratio.

A data stream including L and H frames encoded in the method described above is transmitted by wire or wirelessly to a decoding apparatus or is delivered via recording media. The decoding apparatus restores the original video signal in the enhanced and/or base layer according to the method described below.

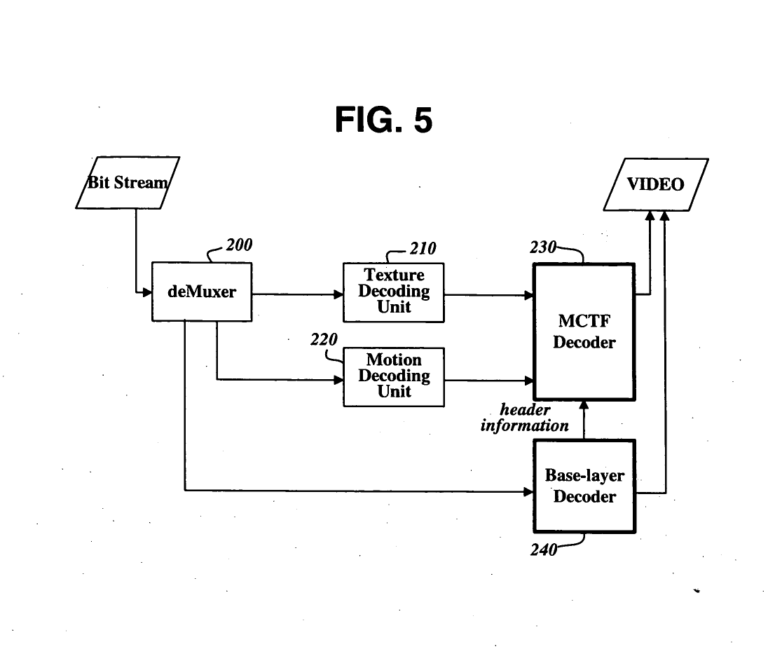

FIG. 5 is a block diagram of an apparatus for decoding a data stream encoded by the apparatus of FIG. 2. The decoding apparatus of FIG. 5 includes a demuxer (or demultiplexer) 200, a texture decoding unit 210, a motion decoding unit 220, an MCTF decoder 230, and a base layer decoder 240. The demuxer 200 separates a received data stream into a compressed motion vector stream, a compressed macroblock information stream, and a base layer stream. The texture decoding unit 210 restores the compressed macroblock information stream to its original uncompressed state. The motion decoding unit 220 restores the compressed motion vector stream to its original uncompressed state. The MCTF decoder 230 converts the uncompressed macroblock information stream and the uncompressed motion vector stream back to an original video signal according to an inverse MCTF scheme. The base layer decoder 240 decodes the base layer stream according to a specified scheme, for example, according to the MPEG-4 or H.264 standard. The base layer decoder 240 not only decodes an input base layer stream but also provides header information in the stream to the MCTF decoder 230 to allow the MCTF decoder 230 to use encoding information of the base layer, for example, information regarding the motion vectors.

The MCTF decoder 230 includes therein an inverse filter for restoring an input stream to an original frame sequence.

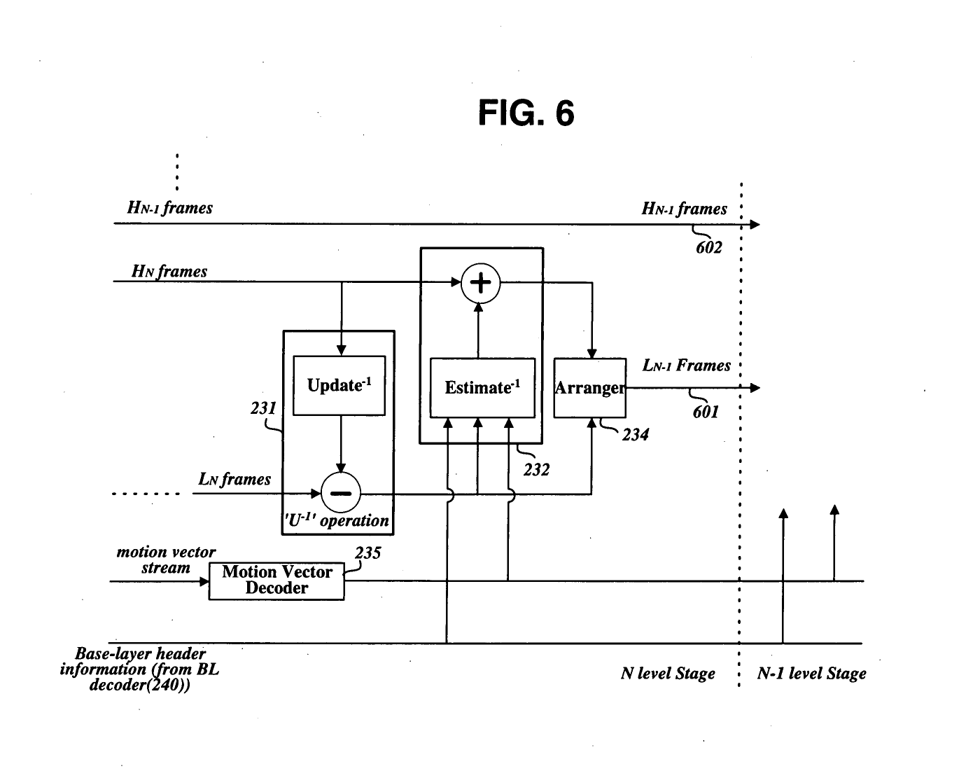

FIG. 6 is a block diagram showing part of the inverse filter responsible for restoring a sequence of H and L frames of MCTF level N to an L frame sequence of MCTF level N−1. The elements of the inverse filter shown in FIG. 6 include an inverse updater 231, an inverse predictor 232, a motion vector decoder 235, and an arranger 234. The inverse updater 231 subtracts pixel difference values of input H frames from corresponding pixel values of input L frames. The inverse predictor 232 restores input H frames to L frames having original images using the H frames and the updated L frames output from inverse updater 231. The motion vector decoder 235 decodes an input motion vector stream into motion vector information of macroblocks in H frames and provides the motion vector information to an inverse predictor (for example, the inverse predictor 232) of each stage. The arranger 234 interleaves the L frames completed by the inverse predictor 232 between the L frames output from the inverse updater 231, thereby producing a normal sequence of L frames.

L frames output from the arranger 234 constitute an L frame sequence 601 of level N−1. A next-stage inverse updater and predictor of level N−1 restores the L frame sequence 601 and an input H frame sequence 602 of level N−1 to an L frame sequence. This decoding process is performed the same number of times as the number of MCTF levels employed in the encoding procedure, thereby restoring an original video frame sequence.

A more detailed description will now be given of how H frames of level N are restored to L frames according to an embodiment of the present invention. First, for an input L frame, the inverse updater 231 subtracts error values (i.e., image differences) of macroblocks in the H frames, whose image differences have been obtained using blocks in the L frame as reference blocks, from the respective blocks of the L frame.

For each target macroblock of a current H frame, the inverse predictor 232 checks information regarding the motion vector of the target macroblock. If the information indicates that the motion vector of the target macroblock is identical to a derivative vector from the base layer, the inverse predictor 232 obtains a scaled motion vector mvScaledBL from a motion vector mvBL of a corresponding block in a base layer predictive image frame, which is one of the two base layer frames temporally adjacent to the current enhanced layer H frame, provided from the BL decoder 240 by scaling up the motion vector mvBL by the ratio of the display size of enhanced layer frames to the display size of base layer frames. The inverse predictor 232 then derives the actual vector (mv=mv′) according to Equations (1a) and (1b) or Equations (2a) and (2b). If the information regarding the motion vector indicates that a difference vector from a derivative vector has been coded, the inverse predictor 232 obtains an actual motion vector mv of the target macroblock by adding a vector mv′ derived by Equations (1a) and (1b) or Equations (2a) and (2b) to the difference vector (mv−mv′) of the target macroblock provided by the motion vector decoder 235.

The inverse predictor 232 determines a reference block, present in an adjacent L frame, of the target macroblock of the current H frame with reference to the actual vector derived from the base layer motion vector or with reference to the directly coded actual motion vector, and restores an original image of the target macroblock by adding pixel values of the reference block to difference values of pixels of the target macroblock. Such a procedure is performed for all macroblocks in the current H frame to restore the current H frame to an L frame. The arranger 234 alternately arranges L frames restored by the inverse predictor 232 and L frames updated by the inverse updater 231, and provides such arranged L frames to the next stage.

As with encoding, to obtain the actual vector of the target macroblock, the inverse predictor 232 may multiply the motion vector mvBL in the base layer by the time difference ratio and then scale up the multiplied motion vector, instead of scaling up the motion vector mvBL in the base layer and multiplying the scaled motion vector mvScaledBL by the time difference ratio.

The above decoding methods restore an MCTF-encoded data stream to a complete video frame sequence. In the case where the estimation/prediction and update operations have been performed for a GOP N times in the MCTF encoding procedure described above, a video frame sequence with the original image quality is obtained if the inverse prediction and update operations are performed N times. However, a video frame sequence with a lower image quality and at a lower bitrate may be obtained if the inverse prediction and update operations are performed less than N times. Accordingly, the decoding apparatus is designed to perform inverse prediction and update operations to the extent suitable for its performance.

The decoding apparatus described above may be incorporated into a mobile communication terminal or the like, into a media player, etc.

As is apparent from the above description, a method and apparatus for encoding/decoding video signals according to embodiments of the present invention has several advantages. During MCTF encoding, motion vectors of macroblocks of the enhanced layer are coded using motion vectors of the base layer provided for low performance decoders, thereby eliminating redundancy between motion vectors of temporally adjacent frames. This reduces the amount of coded motion vector data, thereby increasing the MCTF coding efficiency.

The invention being thus described, it will be obvious that the same may be varied in many ways. Such variations are not to be regarded as a departure from the invention, and all such modifications are intended to be included within the scope of the invention.

What is claimed is:

1. A method of decoding a first frame sequence layer, comprising:
determining at least one motion vector of an image block in a frame of the first frame sequence layer based on a motion vector for an image block in a frame of a second frame sequence layer, the frame of the second frame sequence layer being temporally separated from the frame of the first frame sequence layer; and
decoding the image block in the frame of the first frame sequence layer based on the determined motion vector.

2. The method of claim 1, wherein the second frame sequence layer does not include a frame temporally coincident with the frame of the first frame sequence layer.

3. The method of claim 1, wherein frames of the second frame sequence layer are spatially decimated with respect to frames of the first frame sequence layer.

4. The method of claim 1, wherein a bitrate of a bitstream representing the second frame sequence layer is less than a bitrate of a bitstream representing the first frame sequence layer.

5. The method of claim 1, wherein a display size of frames in the second frame sequence layer is different than a display size of frames in the first frame sequence layer.

6. The method of claim 5, wherein the display size of frames in the second frame sequence layer is less than a display size of frames in the first frame sequence layer.

7. The method of claim 5, wherein the determining step comprises:
determining a scaled motion vector of the image block in the frame of the second frame sequence layer; and
determining at least one motion vector of the image block in the frame of the first frame sequence layer based on the determined scaled motion vector and a temporal difference between the frame of the first frame sequence layer and the frame of the second frame sequence layer.

8. The method of claim 7, wherein the determining a scaled motion vector step scales a motion vector of the image block in the frame of the second frame sequence layer based on a display size difference between frames in the first frame sequence layer and frames in the second frame sequence layer.

9. The method of claim 8, further comprising:
obtaining motion vector information from the first frame sequence layer, the motion vector information indicating whether the motion vector for the image block in the frame of the first frame sequence layer equals a derivative of the motion vector for the image block in the frame of the second frame sequence layer; and wherein
the determining at least one motion vector of the image block in the frame of the first frame sequence layer step determines the derivative motion vector based on the determined scaled motion vector and a temporal difference between the frame of the first frame sequence layer and the frame of the second frame sequence layer, and sets the motion vector of the image block in the frame of the first frame sequence layer equal to the derivative motion vector if the motion vector information indicates that the motion vector for the image block in the frame of the first frame sequence layer equals the derivative motion vector for the image block in the frame of the second frame sequence layer.

10. The method of claim 8, further comprising:
obtaining motion vector information from the first frame sequence layer, the motion vector information indicating whether motion vector offset information for the image block in the frame of the first frame sequence layer is included in the first frame sequence layer; and wherein
the determining at least one motion vector of the image block in the frame of the first frame sequence layer step determines a derivative motion vector based on the determined scaled motion vector and a temporal difference between the frame of the first frame sequence layer and the frame of the second frame sequence layer, and sets the motion vector of the image block in the frame of the first frame sequence layer equal to a motion vector offset obtained from the motion vector offset information plus the derivative motion vector if the motion vector information indicates that motion vector offset information is included in the first frame sequence layer.

11. The method of claim 5, wherein the determining step comprises:
determining a derivative motion vector by altering the motion vector of the image block in the frame of the second frame sequence layer based on a temporal difference between the frame of the first frame sequence layer and the frame of the second frame sequence layer and then scaling the altered motion vector; and
determining at least one motion vector of the image block in the frame of the first frame sequence layer based on the derivative motion vector.

12. The method of claim 11, wherein the determining a derivative motion vector step scales the altered motion vector based on a display size difference between frames in the first frame sequence layer and frames in the second frame sequence layer.

13. The method of claim 12, further comprising:
obtaining motion vector information from the first frame sequence layer, the motion vector information indicating whether the motion vector for the image block in the frame of the first frame sequence layer equals and the derivative motion vector; and wherein
the determining at least one motion vector of the image block in the frame of the first frame sequence layer step sets the motion vector of the image block in the frame of the first frame sequence layer equal to the derivative motion vector if the motion vector information indicates that the motion vector for the image block in the frame of the first frame sequence layer equals the derivative motion vector.

14. The method of claim 12, further comprising:
obtaining motion vector information from the first frame sequence layer, the motion vector information indicating whether motion vector offset information for the image block in the frame of the first frame sequence layer is included in the first frame sequence layer; and wherein
the determining at least one motion vector of the image block in the frame of the first frame sequence layer step determines a derivative motion vector based on the determined scaled motion vector and a temporal difference between the frame of the first frame sequence layer and the frame of the second frame sequence layer, and sets the motion vector of the image block in the frame of the first frame sequence layer equal to a motion vector offset obtained from the motion vector offset information plus the derivative motion vector if the motion vector information indicates that motion vector offset information is included in the first frame sequence layer.

15. The method of claim 5, wherein the determining step determines at least one motion vector of the image block in the frame of the first frame sequence layer based on the motion vector of the image block in the frame of the second frame sequence layer, a display size difference between frames in the first frame sequence layer and frames in the second frame sequence layer, and a time difference between the frame of the first frame sequence layer and the frame of the second frame sequence layer.

16. The method of claim 15, wherein the determining step further determines the at least one motion vector of the image block in the frame of the first frame sequence layer based on whether a direction to a reference block of the image block in the frame of the first frame sequence layer and a direction of the motion vector of the image block in the frame of the second frame sequence layer are a same direction.

17. The method of claim 16, wherein the motion vector of the image block in the frame of the second frame sequence layer spans a time interval including the frame of the first frame sequence layer.

18. The method of claim 16, wherein the motion vector of the image block in the frame of the second frame sequence layer does not span a time interval including the frame of the first frame sequence layer.

19. The method of claim 1, further comprising:
obtaining motion vector information from the first frame sequence layer; and wherein
the determining step determines at least one motion vector of the image block in the frame of the first frame sequence layer based on the motion vector for the image block in the frame of the second frame sequence layer and the obtained motion vector information.

20. The method of claim 19, wherein the motion vector information indicates whether the motion vector of the image block in the frame of the first frame sequence layer equals a derivative of the motion vector of the image block in the frame of the second frame sequence layer.

21. The method of claim 19, wherein the motion vector information indicates whether the first frame sequence layer includes motion vector offset information for the image block in the frame of the first frame sequence layer.

22. The method of claim 19, wherein the obtaining step obtains the motion vector information from a header of the image block in the frame of the first frame sequence layer.

23. The method of claim 1, wherein the frame of the second frame sequence layer is a predictive frame.

24. The method of claim 23, wherein the predictive frame is one of temporally subsequent and temporally prior to the frame of the first frame sequence layer.

25. The method of claim 1, wherein the first frame sequence layer includes first and second types of encoded frames.

26. The method of claim 25, wherein the first type of encoded frame is an image difference type, and the frame of the first frame sequence layer is an image difference type of frame.

27. The method of claim 26, wherein the frame of the first frame sequence layer is an H frame.

28. A method of decoding a first frame sequence layer, comprising:
receiving the first frame sequence layer and a second frame sequence layer, a display size of frames in the second frame sequence layer being less than a display size of frames in the first frame sequence layer;
determining at least one motion vector of an image block in a frame of the first frame sequence layer based on a motion vector for an image block in a frame of a second frame sequence layer, a display size difference between frames in the first frame sequence layer and frames in the second frame sequence layer, and a time difference between the frame of the first frame sequence layer and the frame of the second frame sequence layer, the frame of the second frame sequence layer being temporally separated from the frame of the first frame sequence layer; and
decoding the image block in the frame of the first frame sequence layer based on the determined motion vector.

29. A method of encoding a video signal, comprising:
encoding the video signal to produce a first frame sequence layer and a second frame sequence layer, at least one frame in the first frame sequence layer including an image block having motion vector information derived based on a motion vector for an image block in a frame of the second frame sequence layer, the frame of the second frame sequence layer being temporally separated from the frame in the first frame sequence layer.

30. An apparatus for decoding a first frame sequence layer, comprising:
a first frame sequence layer decoder configured to determine at least one motion vector of an image block in a frame of the first frame sequence layer based on a motion vector for an image block in a frame of a second frame sequence layer, the frame of the second frame sequence layer being temporally separated from the frame of the first frame sequence layer, and the first frame sequence layer configured to decode the image block in the frame of the first frame sequence layer based on the determined motion vector; and
a second frame sequence layer decoder configured to receive the second frame sequence layer and output the motion vector of the image block in the frame of the second frame sequence layer.

31. An apparatus for encoding a video signal, comprising:
a first encoder configured to encode the video signal to produce a first frame sequence layer;
a second encoder configured to encode the video signal to produce a second frame sequence layer;
the first encoder configured to produce at least one frame in the first frame sequence layer including an image block having motion vector information derived based on a motion vector for an image block in a frame of the second frame sequence layer, the frame of the second frame sequence layer being temporally separated from the frame in the first frame sequence layer.
